(19) United States
(12) Patent Application Publication
(10) Pub. No.: US 2008/0137726 A1
(43) Pub. Date: Jun. 12, 2008

(54) Method and Apparatus for Real-Time Video Encoding

(75) Inventors: Chanchal Chatterjee, Encinitas, CA (US); Robert O. Eifrig, San Diego, CA (US); Robert S. Nemiroff, Carlsbad, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/609,572

(22) Filed: Dec. 12, 2006

(51) Int. Cl. H04N 11/04

(52) U.S. Cl. 375/240.01

(57) ABSTRACT

A real-time encoder, e.g., a real-time H.264 compliant encoder or a real-time AVC compliant encoder is disclosed. For example, the encoder comprises a first digital signal processor (DSP) for processing a first panel of an input image and a second digital signal processor (DSP) for processing a second panel of the input image. Finally, the encoder comprises a field programmable gate array (FPGA) for supporting both the first DSP and the second DSP.

### BACKGROUND OF THE INVENTION

1. Field of the Invention

The present invention relates to video encoders and, more particularly, to a method and apparatus for a real-time video encoder.

2. Description of the Background Art

The International Telecommunication Union (ITU) H.264 video coding standard is able to compress video much more efficiently than earlier video coding standards, such as ITU H.263, MPEG-2 (Moving Picture Experts Group), and MPEG-4. H.264 is also known as MPEG-4 Part 10 and Advanced Video Coding (AVC). H.264 exhibits a combination of new techniques and increased degrees of freedom in using existing techniques. Among the new techniques defined in H.264 are 4×4 discrete cosine transform (DCT), multi-frame prediction, context adaptive variable length coding (CAVLC), SI/SP frames, and context-adaptive binary arithmetic coding (CABAC). The increased degrees of freedom come about by allowing multiple reference frames for prediction and many more tessellations of a 16×16 pixel macroblock. These new tools and methods add to the coding efficiency at the cost of increased encoding and decoding complexity in terms of logic, memory, and number of operations. This complexity far surpasses those of H.263 and MPEG-4 and begs the need for efficient implementations.

The H.264 standard belongs to the hybrid motion-compensated DCT (MC-DCT) family of codecs. H.264 is able to generate an efficient representation of the source video by reducing temporal and spatial redundancies and allowing distortions. Temporal redundancies are removed by a combination of motion estimation (ME) and motion compensation (MC). ME is the process of estimating the motion of a current frame in the source video from previously coded frame(s). This motion information is used to motion compensate the previously coded frame(s) to form a prediction. The prediction is then subtracted from the original frame to form a displaced frame difference (DFD). The motion information is present for each block of pixel data. In H.264, there are seven possible block sizes within a macroblock—16×16, 16×8, 8×16, 8×8, 8×4, 4×8, and 4×4 (also referred to as tessellations or partitions). Thus, a 16×16 pixel macroblock (MB) can be tessellated into: (A) one 16×16 macroblock region; (B) two 16×8 tessellations; (C) two 8×16 tessellations; and (D) four 8×8 tessellations. Furthermore, each of the 8×8 tessellations can be decomposed into: (a) one 8×8 region; (b) two 8×4 regions; (c) two 4×8 regions; and (d) four 4×4 regions.

Thus, there are 41 possible tessellations of a single macroblock. Further, the motion vector for each block is unique and can point to different reference frames. The job of the encoder is to find the optimal way of breaking down a 16×16 macroblock into smaller blocks (along with the corresponding motion vectors) in order to maximize compression efficiency. This breaking down of the macroblock into a specific pattern is commonly referred to as “mode selection” or “mode decision.”

However, current mode selection and mode decision processes demand a significant amount of resources from an encoder, thereby hindering performance and processing times. This results in an overwhelming increase in complexity, rendering the encoder practically non-realizable in some applications, such as real-time applications. Accordingly, there exists a need in the art for a real-time encoder capable of generating video streams in a more efficient manner.

### SUMMARY OF THE INVENTION

In one embodiment, the present invention discloses a real-time encoder, e.g., a real-time H.264 compliant encoder or a real-time AVC compliant encoder. For example, the encoder comprises a first digital signal processor (DSP) for processing a first panel of an input image and a second digital signal processor (DSP) for processing a second panel of the input image. Finally, the encoder comprises a field programmable gate array (FPGA) for supporting both the first DSP and the second DSP.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a video encoder;

FIG. 2 is a block diagram depicting an encoding system or encoder of the present invention;

FIG. 3 is a block diagram depicting macroblock processing orders that are performed for interlaced frames in accordance with one or more aspects of the invention;

FIG. 4 is a block diagram of an exemplary macroblock processing order that is performed for progressive frames in accordance with one or more aspects of the invention;

FIG. 5 is a block diagram of a macroblock adaptive frame field (MBAFF) neighborhood that is arranged in a manner that is in accordance with one or more aspects of the present invention;

FIG. 6 is a flow diagram depicting an exemplary embodiment of a method for processing macroblocks in a two phase manner in accordance with one or more aspects of the invention; and

FIG. 7 is a block diagram depicting an exemplary embodiment of a video encoder in accordance with one or more aspects of the invention.

To facilitate understanding, identical reference numerals have been used, where possible, to designate identical elements that are common to the figures.

### DETAILED DESCRIPTION OF THE INVENTION

Method and apparatus for implementing a video encoder is described. More specifically, the present invention discloses an implementation of a real-time H.264 encoder. As discussed above, as encoding methods incorporate ever more complex algorithms, there is a need to provide a hardware implementation where the complex encoding algorithms can be implemented in real time applications.

Before describing the present hardware architecture, a brief description of the various encoding functions performed by an H.264 encoder or an H.264-like encoder are first described. One or more of these encoding functions are then described in the context of the present hardware architecture, thereby illustrating the real-time processing capability of the present hardware architecture.

Embodiments of the invention use the following definitions:
R Theoretical rate (bit-rate) of the encoder
D Theoretical distortion of the encoder
\hat{R} Real-time estimate of R for a given macroblock
\hat{D} Real-time estimate of D
SAD Minimized sum of absolute differences between a block and its corresponding reference block or any similar metric
QP Quantization parameter
MV Motion vector for a macroblock or block
PMV Motion vector predictor for a macroblock or block that is used for encoding a motion vector differentially
MB_TYPE Partitioning of macroblock: one of 16×16, 16×8, 8×16, and 8×8
SUB_MB_TYPE Partitioning of 8×8 block: one of 8×8, 8×4, 4×8, and 4×4
MODE INTER macroblock partitioning. This is the set of values of MB_TYPE and SUB_MB_TYPE
\hat{R}_{DCT} Estimated bits needed to encode DCT data
\hat{R}_{MV} Estimated bits needed to encode motion vectors
\hat{R}_{MODE} Estimated bits needed to encode mode information (MB_TYPE and SUB_MB_TYPE)
\hat{R}_{MISC} Estimated bits needed to encode other miscellaneous data that is independent of the mode decision

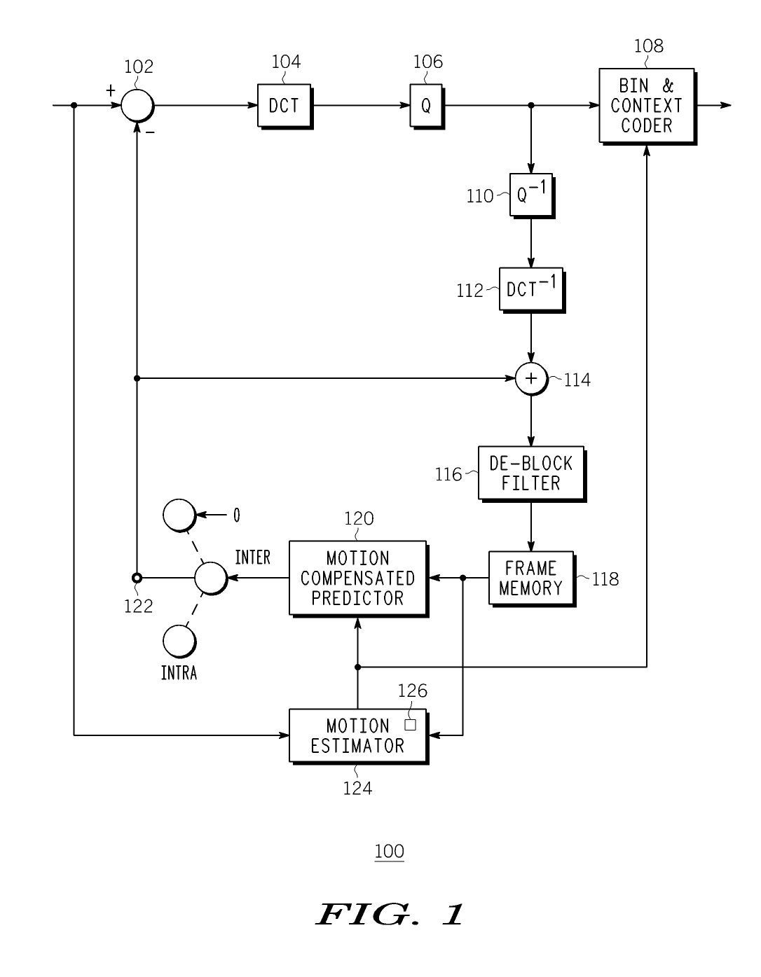

FIG. 1 is a block diagram depicting an exemplary embodiment of a video encoder 100. Since FIG.1 is intended to only provide an illustrative example of a H.264 encoder, FIG. 1 should not be interpreted as limiting the present invention. In one embodiment, the video encoder is compliant with the H.264 standard. The video encoder 100 may include a subtractor 102, a discrete cosine transform (DCT) module 104, a quantizer 106, a bin and context coder 108, an inverse quantizer 110, an inverse DCT module 112, a summer 114, a deblocking filter 116, a frame memory 118, a motion compensated predictor 120, an intra/inter switch 122, and a motion estimator 124. In operation, the video encoder 100 receives an input sequence of source frames. The subtractor 102 receives a source frame from the input sequence and a predicted frame from the intra/inter switch 122. The subtractor 102 computes a difference between the source frame and the predicted frame, which is provided to the DCT module 104. In INTER mode, the predicted frame is generated by the motion compensated predictor 120. In INTRA mode, the predicted frame is zero and thus the output of the subtractor 102 is the source frame.

The DCT module 104 transforms the difference signal from the pixel domain to the frequency domain using a DCT algorithm to produce a set of coefficients. The quantizer 106 quantizes the DCT coefficients. The entropy coder 108 codes the quantized DCT coefficients to produce a coded frame. [0021]The inverse quantizer 110 performs the inverse operation of the quantizer 106 to recover the DCT coefficients. The inverse DCT module 112 performs the inverse operation of the DCT module 104 to produce an estimated difference signal. The estimated difference signal is added to the predicted frame by the summer 114 to produce an estimated frame, which is coupled to the deblocking filter 116. The deblocking filter deblocks the estimated frame and stores the estimated frame or reference frame in the frame memory 118. The motion compensated predictor 120 and the motion estimator 124 are coupled to the frame memory 118 and are configured to obtain one or more previously estimated frames (previously coded frames).

The motion estimator 124 also receives the source frame. The motion estimator 124 performs a motion estimation algorithm using the source frame and a previous estimated frame (i.e., reference frame) to produce motion estimation data. For example, the motion estimation data includes motion vectors and minimum SADs for the macroblocks of the source frame. The motion estimation data is provided to the entropy coder 108 and the motion compensated predictor 120. The entropy coder 108 codes the motion estimation data to produce coded motion data. The motion compensated predictor 120 performs a motion compensation algorithm using a previous estimated frame and the motion estimation data to produce the predicted frame, which is coupled to the intra/inter switch 122. Motion estimation and motion compensation algorithms are well known in the art.

To illustrate, the motion estimator 124 may include mode decision logic 126. The mode decision logic 126 can be configured to select a mode for each macroblock in a predictive (INTER) frame. The “mode” of a macroblock is the partitioning scheme. That is, the mode decision logic 126 selects MODE for each macroblock in a predictive frame, which is defined by values for MB_TYPE and SUB_MB_TYPE. For example, an R-D optimization method may attempt to minimize the Lagrangian cost function. In one embodiment, the mode decision logic 126 may optimize an estimated cost function, defined as:

Ĵ=\hat{D}+λ\hat{R} Eq. 2

The estimate \hat{D} is mainly a function of QP and represents distortion. QP is a fixed value for a macroblock. In one embodiment, \hat{D}(QP,SAD) is assumed to be constant for a given QP. Assuming that \hat{D} is constant for a macroblock, RD optimization reduces to a minimization of \hat{R}, which is the estimate of the number of bits needed to encode a macroblock. \hat{R} can be broken down into components of \hat{R}_{DCT}, \hat{R}_{MV}, \hat{R}_{MODE},and \hat{R}_{MISC}.

The quantity \hat{R}_{MISC} is the component that is independent of the mode decision (e.g., bits for the quantization parameter, QP). The quantity \hat{R}_{MV} is the bit cost for transmitting the motion vector. The value can be computed exactly for a given motion vector without actually encoding. The quantity \hat{R}_{MODE} is the bit cost associated with encoding the mode. This can be determined exactly without encoding the data. The quantity \hat{R}_{DCT} is all the bits associated with encoding the residual block data. This includes bits to encode “coded_block_pattern,” the zeros, and run and levels for DCT coefficient. It is not feasible to compute \hat{R}_{DCT} exactly without actually going through the encoding process. Hence, in one embodiment, the function \hat{R}_{DCT} (QP) is calculated statistically through simulations.

The above description only provides a brief view of the various complex algorithms that must be executed to provide the encoded bitstreams generated by an H.264 encoder. The increase in complexity is often a result of a desire to provide better encoding characteristics, e.g., less distortion in the encoded images while using less number of bits to transmit the encoded images. In order to achieve these improved encoding characteristics, it is often necessary to increase the overall computational overhead of an encoder. Unfortunately, the increase in computational overhead also increases the difficulty in implementing a real-time H.264 encoder.

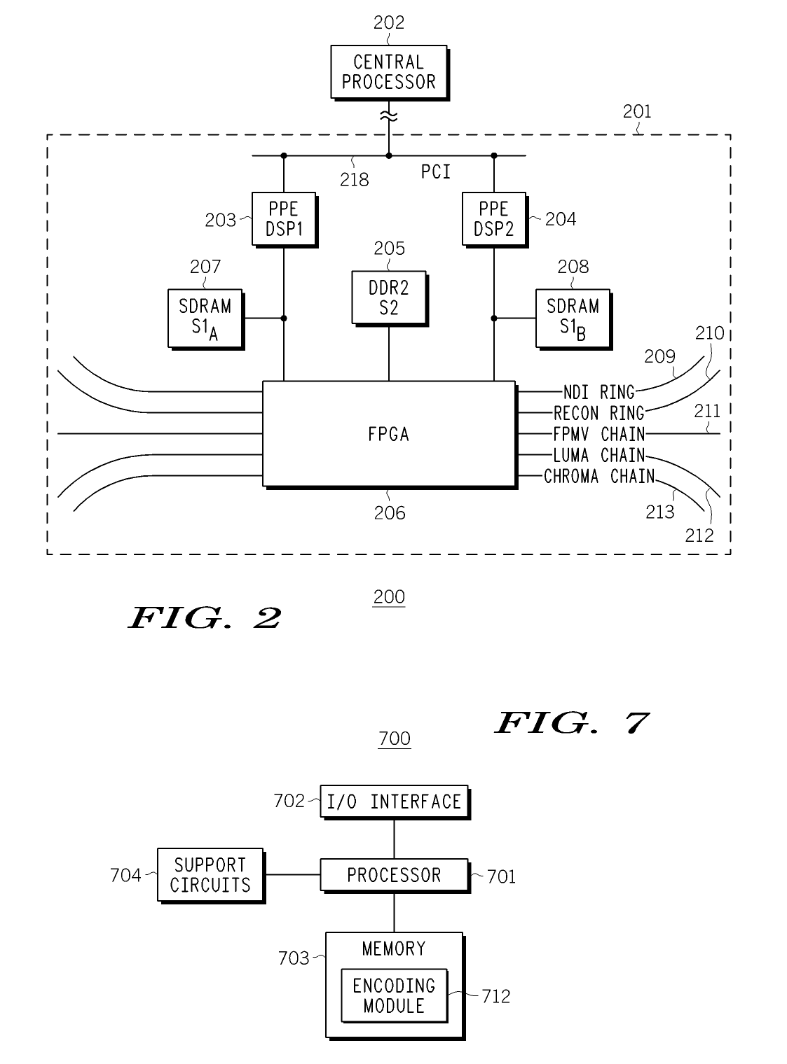

FIG. 2 depicts one embodiment of an encoding system or encoder 200 of the present invention. In one embodiment, the encoding system or encoder 200 employs a central processor 202 and one or more panel processing element (PPE) pair digital signal processor (DSP) unit or module 201. In one embodiment, the PPE pair DSP unit 201 comprises of a pair of digital signal processors, PPE DSP1 203 and PPE DSP2 204. The two PPE DSPs are coupled together via a PCI connection, which enables the pair of DSPs to function and work together. Each PPE DSP is respectively connected to a memory, e.g., a synchronous dynamic random access memory (SDRAM) unit (e.g., S1_{A} 207 and SDRAM S1_{B} 208) over an EMIF A and B. Similarly, both PPE DSPs are also respectively connected to a single field programmable gate array (FPGA) 206 (e.g., a quarter pixel FPGA that is dedicated to perform Quarter-Pel (QP) motion estimation). The FPGA 206 is also coupled to a memory, e.g., a DDR2 S2 module 205.

It should be noted that FIG. 2 only shows a portion of a much larger encoding system. More specifically, a real time encoding system may simultaneously deploy a number of PPE pair unit 201s, where they are in communication with each other via a communication channel. For example, the communication channel can be implemented as a ring communication structure having a plurality of rings or chains as further discussed below.

One novel aspect of the present invention is the unique interactions of the FPGA 206 and the two DSPs 203-204 in each PPE pair unit 201. More specifically, one unique aspect is the ability of each PPE pair unit 201 to perform load balancing between the two DSPs 203-204 and the FPGA 206. For example, in one embodiment, the FPGA is performing quarter-pel motion estimation (among other functions) in support of both DSPs. For example, when the FPGA is finished with performing the quarter-pel computation for one DSP, it will then perform the quarter-pel computation for the other DSP, and then back to the first DSP and so on. This ability to distribute complex encoding algorithms to be performed among the two DSPs and the FPGA allows the present real-time H.264 to be realized. Furthermore, the use of a plurality of PPE pair unit 201s further increases the capability of the present hardware architecture where it can easily be scaled to handle images of different image resolutions.

In one embodiment of the present invention, each PPE pair unit 201 is tasked with processing two successive panels of an input image. A panel is broadly defined as comprising “x” number of rows of macroblocks of the input image, where x is an even number. Thus, an input image can be divided, at minimum, into two panels, or it can be divided, at maximum, into “y” number of panels, where y represents the number of rows of macroblocks of an input image divided by two. As such, in one embodiment, if there are only two panels for each input image, then a single PPE pair unit 201 can be used to process the input image. However, if there are 4 panels, then two PPE pair unit 201s are used to process the input image and so on.

Thus, the FPGA 206 may be connected to other FPGAs 206 that exist in the overall encoding system via a plurality of connections, such as a neighborhood and deblock interface (NDI) ring or chain 209, a RECON ring or chain 210, a full pel motion vector (FPMV) ring or chain 211, a luma ring or chain 212, a chroma ring or chain 213, and the like. Each of the ring or chain is providing a separate type of information between the various FPGAs.

In operation, the SDRAM S1 units contain luma and chroma pixels from the current panel macroblocks (MBs), Adaptive Quantization Level (AQL) information, collocated luma motion vectors and Refids (Reference indices) for all partitions, and reconstructed chroma reference pixels for their respective DSP. The DDR2 S2 unit 205, which is attached to the FPGA 206, contains reconstructed luma reference pixels that correspond to the DSP pair 203-204.

In one embodiment, the PPE pair unit 201 obtains various forms of original data from the plurality of rings or chains. Specifically, the DSP may receive original input luma pixel data, original input chroma pixel data, neighborhood and deblock data, and full motion vector data from the luma chain 212, the chroma chain 213, NDI ring 209, and the FPMV chain 211, respectively. The use of the ring communication channel allows the present hardware architecture to provide the real-time processing capability of the present real-time H.264 encoder. Namely, various encoding processes are distributed within the encoding system. For example, full pel motion estimation is performed by a separate motion estimation module (not shown) that is coupled to the ring communication channel. More specifically, the full pel motion vectors are received on the FPMV chain 211.

This distributed processing approach is also implemented within each of the PPE pair unit 201s. For example, spatial and temporal encoding often require information from one or more neighboring macroblocks or one or more neighboring frames. As such, it is often necessary for a processing unit to obtain information from one or more neighboring macroblocks (or previous macroblocks in terms of time) or one or more neighboring frames in order to process a current macroblock. Proper management of how a DSP and an FPGA are used in processing previous macroblocks and a current macroblock will greatly enhance the real-time processing capability of an encoding system.

To illustrate, in general, the PPE DSP pair 203-204 processes the received original data by using the generated quarter pixel motion estimation information that is provided by the FPGA. More specifically, while a DSP is in the process of receiving data for a current macroblock, the FPGA is generating quarter pel motion estimation data for a previous macroblock which is then provided to the DSP. In turn, the DSP will use the quarter pel motion estimation data to perform a mode decision operation for the previous macroblock. Furthermore, the DSP then builds neighborhood information and generates motion compensation data for the current macroblock and forwards both data to the FPGA for processing. The FPGA will use the received data to perform quarter pel processing on the current macroblock.

Having provided the necessary information to the FPGA to work on the current macroblock, the DSP will then turn its attention back to the previous macroblock to complete the processing of the previous macroblock. Namely, the DSP will perform chroma processing, deblocking, and reconstruction on the previous macroblock. The DSP will also then encode the previous macroblock, e.g., using a Context Adaptive Binary Arithmetic Coding (CABAC) video encoding algorithm. The resultant processed data is then sent out as a CABAC stream to the central DSP 202, which is the main processing unit that controls the encoding system or encoder 200, via a PCI connection 218.

In one embodiment, the present invention is configured to process macroblocks (MBs) in various ways. For example, the order in which MBs are processed may depend on the frame resolution be used to display the image (e.g., whether the image utilizes interlaced or progressive frames and how many panels or lines to be utilized).

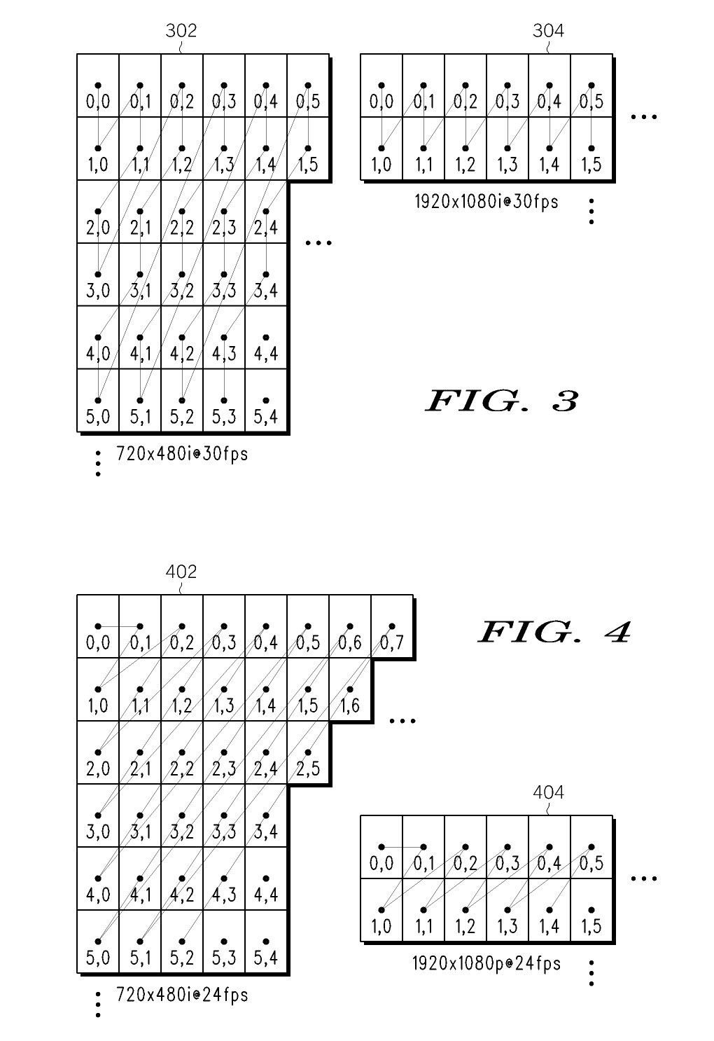

FIG. 3 illustrates the macroblock (MB) process order for a few different types of exemplary interlaced frames. For instance, panel 302 (e.g., having 6 rows of macroblocks) demonstrates a 720×480i interlaced resolution with a frame rate of 30 frames per second (fps). Notably, the panel comprises MB pairs (MBPs) in a series of six rows (and 45 columns, which are not shown) in which a MBP consists of a top MB and a bottom MB (e.g., MB (0,0) and MB (1,0)). In this configuration, the processing order begins at the top MB of the MBP followed by the bottom MB of the MBP while proceeding in a diagonal order illustrated in FIG. 3 (e.g., begin at MB (0,0), continue to MB (1,0), continue to MB (0,1), continue to MB (1,1), continue to MB (2,0), continue to MB (3,0), continue to MB (0,2), and so forth). By implementing a processing order as demonstrated in FIG. 3, a DSP that is tasked with processing this panel 302, is able to rapidly finish at least a portion of a bottom row of MBs (e.g., MB 5,0 and MB 5,1), which in turn allows a next or a following panel (not shown) to begin (e.g., a next panel that will be processed by another DSP). It should be noted that the following panel cannot start to be processed until the last row of macroblocks in this panel 302 is at least partially completed since it needs to acquire some data from the panel above. By being able to process portions of the bottom panel 302 sooner, the overall processing can be completed more efficiently, i.e., more quickly.

Panel 304 (e.g., 2 rows of macroblocks) also demonstrate this processing aspect. Specifically, panel 304 illustrates a panel of only two rows of macroblocks for an input image having a resolution of 1920×1080 in an interlace format.

FIG. 4 illustrates an exemplary MB processing order using progressive frame processing. In one embodiment, for progressive frames, or field pictures (picAFF-field), the processing order may also be characterized by a diagonal processing order, but only deals with single MBs (as opposed to MBPs). For example, panel 402 shows a diagonal processing order where some of the lower MBs are processed prior to some of the top row MBs. For example, MB (5,0), which is positioned on a lower row, is processed prior to MB (0,6), which is located on the first row of the panel 402. However, unlike the interlace format, the progressive processing order allows for a right neighboring MB to be processed first before a lower neighboring MB is processed. For example, after MB (0,0) is processed, MB (0,1) is processed first before MB (1,0) is processed and so on.

Panel 404 (e.g., 2 rows of macroblocks) also demonstrate this progressive processing aspect. Specifically, panel 404 illustrates a panel of only two rows of macroblocks for an input image having a resolution of 1920×1080 in a progressive format.

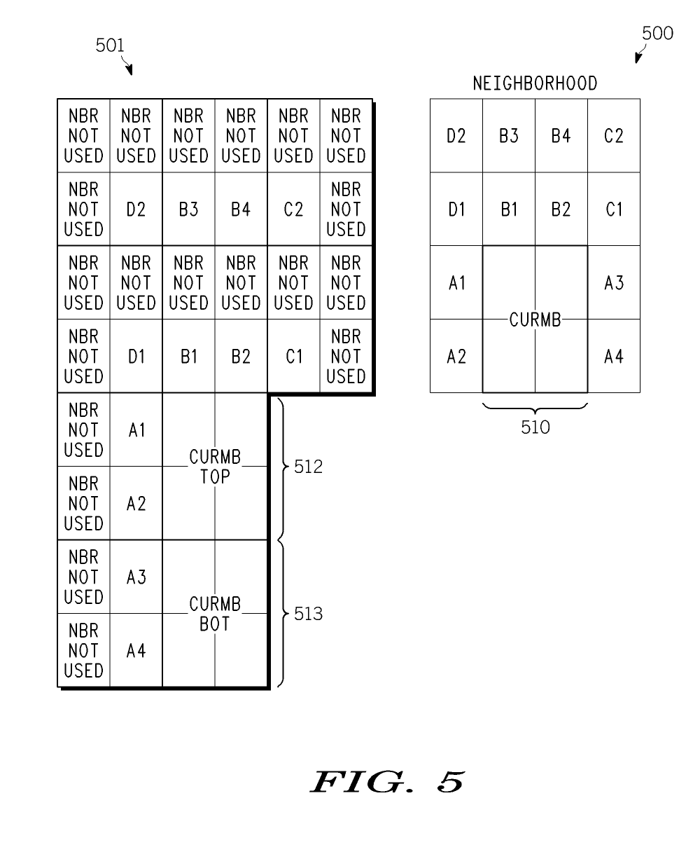

FIG. 5 is a block diagram illustrating a macroblock adaptive frame field (MBAFF) neighborhood 500. It should be noted that for the first MB row in a panel, the top neighboring MBs often belong to a prior panel. These neighboring MBs are often needed for the current MB to compute the predicted MB for the INTRA case. Likewise, these neighboring MBs are required for the current MB to compute the motion vectors, reference indices, PMV calculation, and predicted MB for the INTER case. Furthermore, the “neighborhood” is needed for deblock and CABAC processing.

In one embodiment, the neighborhood 500 comprises a plurality of 8×8 block data structures (e.g., 16 subblocks) that is used to store and compress data in a more efficient manner. Since internal memory is valuable, a macroblock adaptive frame field (MBAFF) neighborhood enables the encoder 100 to store relevant neighboring macroblock data, such as motion vectors (MVs) and Refids, in less space as shown in FIG. 4. In other words, the macroblock adaptive frame field (MBAFF) neighborhood 500 is simply a pictorial representation of the relevant 4×4 subblocks that will be necessary for processing the current macroblock 510 in various encoding processes, e.g., deblocking, and CABAC. This compact representation of the data, e.g., when stored in memory, reduces the amount of necessary memory storage space and may increase processing efficiency because the required information is stored closely for easy access.

More specifically, FIG. 5 illustrates a macroblock pair 512-513 in a frame 501. It should be noted that each macroblock is further illustrated as being divided into a plurality of subblocks, e.g., four subblocks of 8×8. Each subblock of the neighborhood 500 is provided with a unique reference numeral and is correspondingly shown in the image 501 to illustrate where each subblock is obtained from. For example, the bottom eight rows of the top MB and the right four columns of the left MB are needed to perform the deblocking of the current MB 510. Deblocking also requires the MVs and Refids of the neighboring MBs. In order to facilitate the prediction, deblocking, and CABAC, the top neighbor information is passed on to the current DSP via the NDI Ring in NeighborInfo and DeblockInfo structures. For the progressive case, the 8×8 top neighbors need to be passed. For the interlace case, the MBP top neighbors are required. The left neighbors are stored in the current panel's MB data. As such, from the top (top left, direct top, and top right) and left neighbors, a 4×4 neighborhood data structure 500 shown in FIG. 5 is constructed.

The present invention is designed to encode a plurality of macroblocks. Although the MBs are initially received and ultimately encoded in a sequential order (e.g., MB(0), MB(1), MB(2), etc.), the MBs are processed in a unique, non-sequential manner by the present invention. For example, suppose the encoder has previously received one or more prior MBs (e.g., MB(0) and MB(1), which will be explained below) and the encoder initiates the collection of data from a new macroblock (e.g., MB(2)). In one embodiment, the collected data may comprise luma data, chroma data, and co-location data of the new MB. For example, this data can be collected by DSP1 203. After this data is collected, the DSP1 203 begins performing two parallel functions, e.g., processing a current macroblock and processing a previous macroblock. First, the DSP1 203 performs a mode decision operation on a previously processed macroblock (e.g., MB(1)). In one embodiment, the DSP1 203 may ascertain the best three modes from a plurality of different configurations. For example, the encoding system 200 may consider various INTRA modes (e.g., 16×16, 8×8, and 4×4), a plurality of predicted modes (e.g., 16×16, 16×8, and 8×8), a direct mode, and a skipped mode.

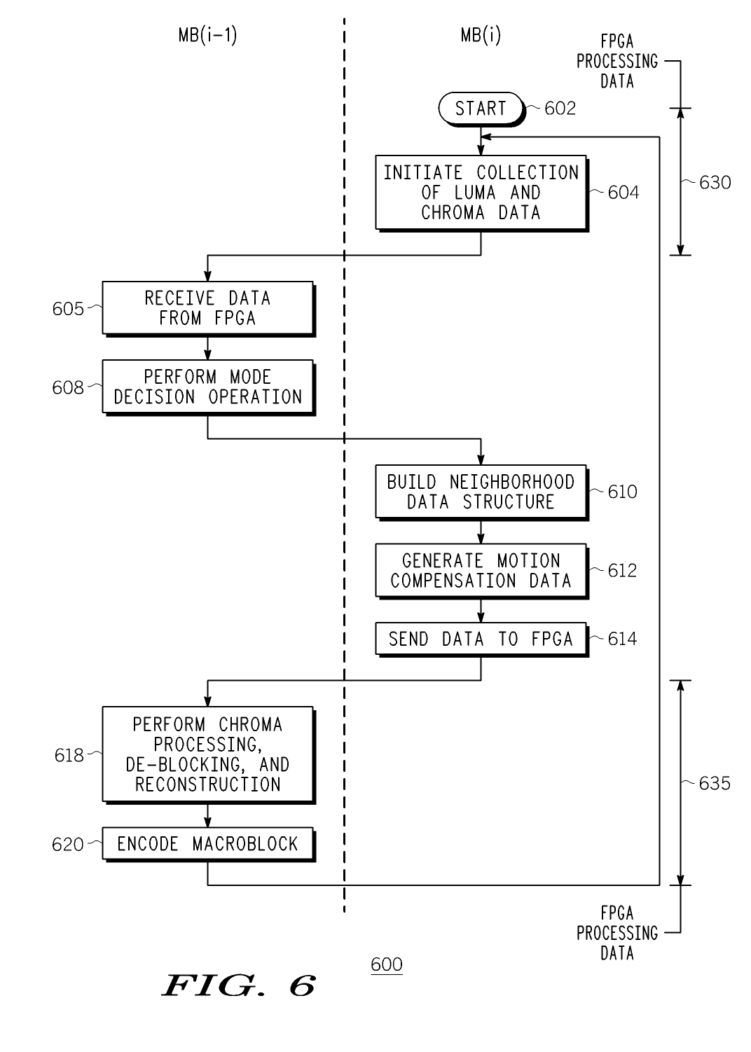

Once the mode decision processing on a previous macroblock is completed, the second operation is performed, i.e., building a neighborhood data structure (e.g., as shown in FIG. 5) for a current MB (e.g., MB(2)). In one embodiment, a plurality of neighborhood structures (e.g., a 4×4, 3×4, 5×5, etc.) is constructed and the best structure is then selected. Using the neighborhood data structure, the DSP1 203 generates motion compensation data for the current MB (i.e., MB(2)). The motion compensation data may be derived by any method that is well known in the art. Afterwards, the DSP1 203 transfers the motion compensation data to the FPGA 206 for further processing. Namely, the DSP1 203 has now provided enough information to the FPGA 206 to start quarter pel processing on the current macroblock. Having done so, at this time, the DSP1 203 begins to perform chroma processing, deblocking operations, and reconstruction processing on the previous MB (i.e., MB(1)). After these processes are completed, the previous MB is encoded. While the DSP1 203 is conducting these steps, a second parallel process is being performed by the FPGA. Specifically, the aforementioned FPGA 206 uses the motion compensation data in performing the quarter pel processing, while the DSP1 203 contemporaneously is performing the chroma processing, deblocking, deconstructing, and encoding processes. The aforementioned mode decision process for MB(2) then takes place and so on. This distributed process is depicted and further described below in FIG. 6.

FIG. 6 depicts the phases of MB processing such that various tasks performed by the DSP can be overlapped with FPGA tasks. More specifically, FIG. 6 is a flow diagram depicting an exemplary embodiment of a method 600 for processing macroblocks in a two phase manner in accordance with one or more aspects of the invention Notably, method 600 is performed in a parallel, non-sequential, and cyclical manner.

The method 600 begins at step 602 and proceeds to step 604 where the luma data, chroma data, and MB co-location data for a current MB (i) are collected. In one embodiment, this data is typically provided over the NDI Ring 209. In the event that the current macroblock is not in the first panel to be processed, the DSP may also obtain neighborhood data over the NDI Ring 209. It should be noted that while the DSP is collecting the data in step 603, FIG. 6 also illustrates the FPGA as processing data in step 630 contemporaneously. For example, the FPGA may be generating quarter pel results for a previous MB for the DSP or it may be servicing another DSP in the PPE pair unit 201.

At step 605, data is received from the FPGA for a previous MB (i-1). For example, quarter pel results may be received from the FPGA.

At step 608, a mode decision operation is performed. More specifically, data processed by the FPGA 206 for a previous MB is utilized in this step. In one embodiment, the DSP performs a mode decision operation on a previous macroblock MB(i-1). The mode decision operation may entail the determination of what motion vectors are associated with the macroblock as well as the partition type of the macroblock (e.g., 16×16, 8×4, 4×4, etc.). In one embodiment, this step is initially skipped if there is not a “previous” MB.

The method 600 continues to step 610 where a neighborhood data structure 500 is built for the current macroblock MB(i). In one embodiment, the neighborhood data structure is a 4×4 MBAFF neighborhood structure as shown in FIG. 5.

At step 612, data is generated, e.g., motion compensation data for a current block MB(i). In one embodiment, the DSP utilizes the collected chroma and luma data to generate motion compensation data that is usable by FPGA 206.

At step 614, the generated data is sent to the FPGA 206.

At step 618, chroma processing, deblocking and reconstructing processes are performed. It should be noted that these processes are preformed on a previous MB (i-1).

The method 600 continues to step 620 where the previous MB(i-1) is encoded and method 600 then returns to step 604 to repeat the process with a new macroblock.

Again, it should be noted that while the DSP is performing the chroma processing, deblocking and reconstructing processes in step 618 and the encoding process in step 620, FIG. 6 also illustrates the FPGA as processing data in step 635 contemporaneously. For example, the FPGA may be generating quarter pel results for the current MB (i) based on the data received in step 614 for the DSP or it may be servicing another DSP in the PPE pair unit 201.

FIG. 7 is a block diagram depicting an exemplary embodiment of a video encoder 700 in accordance with one or more aspects of the invention. The video encoder 700 includes a processor 701, a memory 703, various support circuits 704, and an I/O interface 702. The processor 701 may be any type of processing element known in the art, such as a microcontroller, digital signal processor (DSP), instruction-set processor, dedicated processing logic, or the like. The support circuits 704 for the processor 701 may include conventional clock circuits, data registers, I/O interfaces, and the like. The I/O interface 702 may be directly coupled to the memory 703 or coupled through the processor 701. The I/O interface 702 may be coupled to a frame buffer and a motion compensator, as well as to receive input frames. The memory 703 may include one or more of the following random access memory, read only memory, magneto-resistive read/write memory, optical read/write memory, cache memory, magnetic read/write memory, and the like, as well as signal-bearing media as described below.

In one embodiment, the memory 703 stores processor-executable instructions and/or data that may be executed by and/or used by the processor 701 as described further below. These processor-executable instructions may comprise hardware, firmware, software, and the like, or some combination thereof. Modules having processor-executable instructions that are stored in the memory 703 may include encoding module 712. The encoding module 712 is configured to perform the method 600 of FIG. 6. Although one or more aspects of the invention are disclosed as being implemented as a processor executing a software program, those skilled in the art will appreciate that the invention may be implemented in hardware, software, or a combination of hardware and software. Such implementations may include a number of processors independently executing various programs and dedicated hardware, such as ASICs.

An aspect of the invention is implemented as a program product for execution by a processor. Program(s) of the program product defines functions of embodiments and can be contained on a variety of signal-bearing media (computer readable media), which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to illustrative embodiments of the present invention, other and further embodiments of the invention may be devised without departing from the basic scope thereof, and the scope thereof is determined by the claims that follow.

What is claimed is:

1. An encoder for encoding an input image, comprising:
a first digital signal processor (DSP) for processing a first panel of said input image;
a second digital signal processor (DSP) for processing a second panel of said input image; and
a field programmable gate array (FPGA) for supporting said first DSP and said second DSP.

2. The encoder of claim 1, wherein said input image is processed in real time.

3. The encoder of claim 1, wherein said encoder is an H.264 compliant encoder or an Advanced Video Coding (AVC) compliant encoder.

4. The encoder of claim 1, wherein said FPGA performs quarter pel motion estimation.

5. The encoder of claim 4, wherein said FPGA performs said quarter pel motion estimation contemporaneously while at least one of said first and second DSPs is processing at least one macroblock (MB) of said first panel or said second panel.

6. The encoder of claim 5, wherein said processing at least one macroblock (MB) comprises at least one of: performing mode decision processing for said at least one macroblock (MB), performing chroma processing for said at least one macroblock (MB), performing deblocking processing for said at least one macroblock (MB), performing reconstruction for said at least one macroblock (MB), or performing encoding for said at least one macroblock (MB).

7. The encoder of claim 6, wherein said performing encoding for said at least one macroblock (MB) comprises performing context-adaptive binary arithmetic coding (CABAC).

8. The encoder of claim 4, wherein said quarter pel motion estimation is performed on a current macroblock based on data received on said current macroblock provided by one of said first and second DSPs.

9. The encoder of claim 8, wherein said processing at least one macroblock (MB) comprises processing a previous macroblock.

10. The encoder of claim 1, wherein each of said first and second panels comprises a plurality of rows of macroblocks of said input image.

11. The encoder of claim 10, wherein said a plurality of rows of macroblocks comprises even number of rows of macroblocks.

12. The encoder of claim 8, wherein said data is motion compensation data.

13. The encoder of claim 8, wherein said data is provided in a neighborhood data structure.

14. The encoder of claim 1, wherein said first and second DSPs and said FPGA is deployed as a panel processing element (PPE) pair unit.

15. The encoder of claim 14, further comprising:
a central processor for controlling said panel processing element (PPE) pair unit.

16. The encoder of claim 1, further comprising a plurality of memories, where each of said first and second DSPs and said FPGA is assigned one of said plurality of memories.

17. The encoder of claim 1, wherein said FPGA is coupled to a ring communication channel.

18. The encoder of claim 1, wherein said plurality of macroblocks of each of said first and second panels are processed in a diagonal order.

19. An encoder for encoding an input image, comprising:
a plurality of panel processing element (PPE) pair units, where each of said PPE pair unit comprises:
a first digital signal processor (DSP) for processing a first panel of said input image;
a second digital signal processor (DSP) for processing a second panel of said input image; and
a field programmable gate array (FPGA) for supporting said first DSP and said second DSP; and a central processor for controlling said plurality of panel processing element (PPE) pair units.

20. The encoder of claim 19, wherein said input image is processed in real time.

21. The encoder of claim 19, wherein said encoder is an H.264 compliant encoder or an Advanced Video Coding (AVC) compliant encoder.
